(19) United States
(12) Patent Application Publication
(10) Pub. No.: US 2012/0286964 A1
(43) Pub. Date: Nov. 15, 2012

(54) CABINET FOR ELECTRONIC DEVICES AND OVERWEIGHT ALARM DEVICE THEREOF

(75) Inventors: XIANG CAO, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/216,174

(22) Filed: Aug. 23, 2011

(30) Foreign Application Priority Data
May 12, 2011 (CN) 201110122039.7

(51) Int. Cl. G08B 21/00

(52) U.S. Cl. 340/666

(57) ABSTRACT

An exemplary cabinet for electronic devices includes an enclosure and an overweight alarm device disposed in the enclosure. The enclosure is for accommodating electronic devices therein. The overweight alarm device includes a weighing circuit, an A/D (Analog to Digital) converting circuit, a control circuit and a warning circuit connected in sequence. The weighing circuit includes a weighing sensor mounted at a bottom of the enclosure for sensing a weight of the cabinet. The A/D converting circuit receives the weight from the weighing sensor, converts the weight to a digital signal and outputs the digital signal to the control circuit. The control circuit compares the digital signal with a threshold value contained therein, and controls the warning circuit to generate a warning when the digital signal is greater than the threshold value.

### BACKGROUND

1. Technical Field

The disclosure generally relates to a cabinet for housing electronic devices, the cabinet having an overweight alarm device which can generate a warning when the cabinet is overweight.

2. Description of the Related Art

Electronic devices, such as servers, are frequently housed in modular form in a standardized enclosure. For example, servers are typically rack-mounted in a cabinet. For unified management, the servers are arranged in the cabinet one-by-one from bottom to top; and a plurality of peripheral devices, such as network equipment, extended storages, cables, etc are arranged at one side of the stack of servers.

With rapid developments in information technology (IT), more and more assemblies of servers can be upgraded, such as by providing auxiliary electronic equipment connected to one or more of the servers. Increased numbers of electronic devices placed inside of the cabinet may make the cabinet messy and may significantly add to the weight supported by the cabinet. It is difficult for users to readily know the weight of the contents of the cabinet. When the cabinet stands for a long time with overweight contents, the cabinet is liable to deform and cause damage to the servers and electronic devices inside.

What is desired, therefore, is a cabinet which can overcome the above-described shortcomings.

### BRIEF DESCRIPTION OF THE DRAWINGS

FIG. 1 is an isometric, assembled view of a cabinet for electronic devices according to an exemplary embodiment of the present disclosure.

FIG. 2 is a circuit diagram of an overweight alarm device of the cabinet of FIG. 1.

FIG. 3 is block diagram of the overweight alarm device of FIG. 2.

### DETAILED DESCRIPTION

Reference will now be made to the figures to describe the present cabinet in detail.

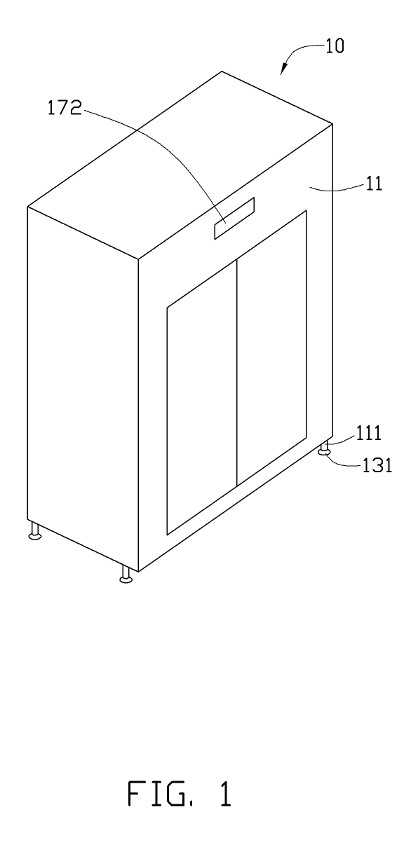

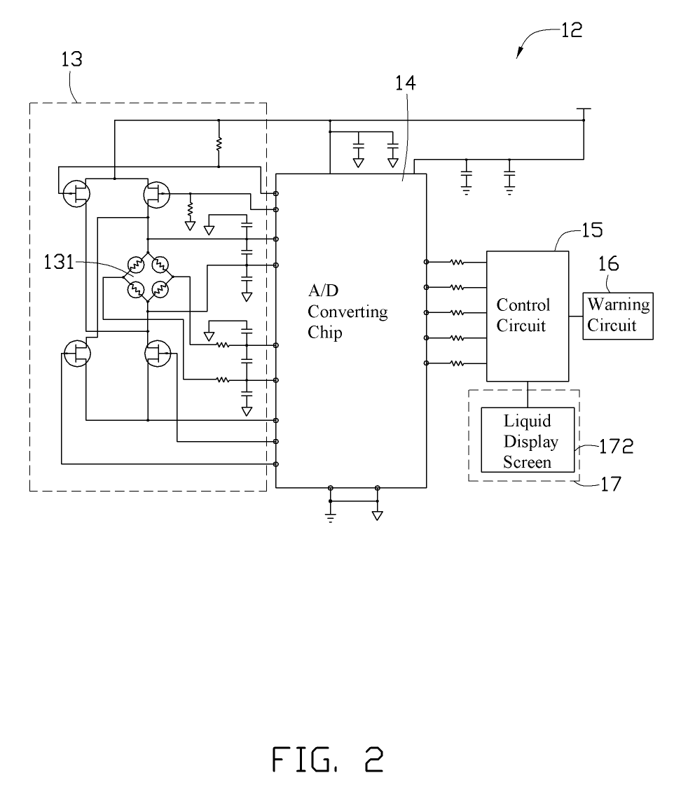

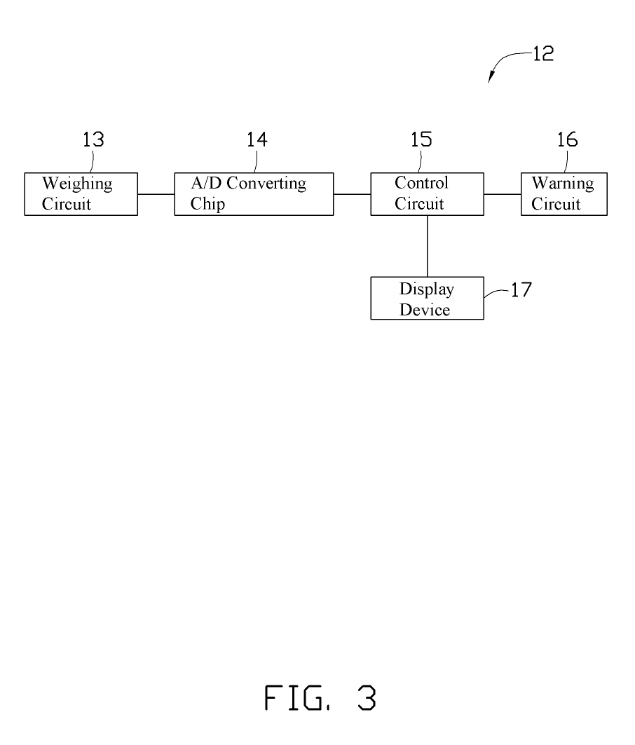

Referring to FIGS. 1-3, a cabinet 10 for holding electronic devices according to an exemplary embodiment of the present disclosure includes an enclosure 11, and an overweight alarm device 12 disposed in the enclosure 11.

The enclosure 11 is generally a hollow rectangular structure, and includes a plurality of electronic devices (such as servers, etc., not shown) received therein. A plurality of supporting legs 111 is mounted at four corners of a bottom side of the enclosure 11, to space the bottom side of the enclosure 11 from the ground (or floor) when the cabinet 10 is put on the ground for use. Thus, moisture on the ground is apt to not enter the enclosure 11 and affect the electronic devices received in the enclosure 11.

The overweight alarm device 12 is configured to warn a user when the contents of the cabinet 10 are overweight. The overweight alarm device 12 includes a weighing circuit 13, an A/D (analog to digital) converting circuit 14, a control circuit 15, a warning circuit 16, and a display device 17.

The weighing circuit 13 includes four weighing sensors 131 mounted at the bottom side of the cabinet 10. The weighing sensors 131 are respectively arranged between bottom ends of the supporting legs 111 and the ground. The weighing sensors 131 cooperatively sense a weight of the cabinet 10 (including the contents thereof), convert the weight of the cabinet 10 to an analog signal containing a message of the weight of the cabinet 10, and then output the analog signal to the A/D converting circuit 14. In alternative embodiments, the number of weighing sensors 131 can vary according to particular requirements.

The A/D converting circuit 14 is electrically connected between the weighing circuit 13 and the control circuit 15. The A/D converting circuit 14 receives the analog signal from the weighing sensors 131, converts the analog signal to a digital signal, and then outputs the digital signal to the control circuit 15. The A/D converting circuit 14 can be an exemplary integrated circuit which can convert analog signals to digital signals, such as an AD7195 chip.

The control circuit 15 is electrically connected with the A/D converting circuit 14. The control circuit 15 contains a reference threshold value therein. The control circuit 15 receives the digital signal from the A/D converting circuit 14, and compares the digital signal with the threshold value. According to the comparison result, the control circuit 15 outputs different control signals to the warning circuit 16, thereby controlling the warning circuit 16 to indicate different states, i.e., an overweight state or a safe state, of the cabinet 10.

More specifically, when the digital signal is larger than the threshold value, this means that the weight of the cabinet 10 is excessive. Accordingly, the control circuit 15 outputs a first control signal to the warning circuit 16 to control the warning circuit 16 to indicate the overweight state of the cabinet 10. When the digital signal is lower than or equal to the threshold value, this means that the weight of the cabinet 10 is within an acceptable range. Accordingly, the control circuit 15 outputs a second control signal to the warning circuit 16 to control the warning circuit 16 to indicate the safe state of the cabinet 10. The control circuit 15 can be a programmable logic chip (PLC) or an advanced RISC machine chip (ARM chip). In this embodiment, the control circuit 15 is an 89C52 PLC.

The warning circuit 16 is electronically connected with the control circuit 15. The warning circuit 16 receives the first and second control signals from the control circuit 15, and generates a warning corresponding to the first control signal to notify the user. The warning circuit 16 can include a sound alarm device which emits an audible sound when the warning circuit 16 receives the first control signal from the control circuit 15, and/or a light alarm device which emits a light with a predetermined color and/or a predetermined flickering frequency when the warning circuit 16 receives the first control signal from the control circuit 15. Thereby, the user is immediately notified that the cabinet 10 is overweight (i.e. that the contents of the cabinet 10 are overweight). In this embodiment, the warning circuit 16 includes a sound alarm device.

The display device 17 includes a liquid display screen 172 embedded at a top end of a front side of the enclosure 11. The display screen 172 is electrically connected with the control circuit 15. The display device 17 displays the weight of the cabinet 10 in real time during operation of the overweight alarm device 12. Therefore the display device 17 provides easy visual monitoring by the user, who can readily know the exact weight of the cabinet 10.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A cabinet for electronic devices, the cabinet comprising:
an enclosure for accommodating a plurality of electronic devices therein; and
an overweight alarm device disposed in the enclosure, the overweight alarm device comprising a weighing circuit, an A/D (Analog to Digital) converting circuit, a control circuit and a warning circuit connected in sequence, the weighing circuit comprising at least one weighing sensor mounted at a bottom of the enclosure for sensing a weight of the cabinet, the A/D converting circuit receiving the weight from the at least one weighing sensor, converting the weight to a digital signal and outputting the digital signal to the control circuit, the control circuit comparing the digital signal with a threshold value contained therein, and controlling the warning circuit to generate a warning when the digital signal is greater than the threshold value.

2. The cabinet of claim 1, wherein the enclosure comprises a plurality of supporting legs mounted at a bottom side thereof.

3. The cabinet of claim 2, wherein the at least one weighing sensors comprises a plurality of weighing sensors corresponding to the supporting legs and respectively mounted at bottom sides of supporting legs.

4. The cabinet of claim 1, further comprising a display device for displaying the weight of the cabinet thereon.

5. The cabinet of claim 4, wherein the display device comprises a liquid display screen embedded in a front side of the enclosure.

6. The cabinet of claim 1, wherein the control circuit outputs a first control signal to the warning circuit when the digital signal is larger than the threshold value and a second control signal to the warning circuit when the digital signal is smaller than the threshold value, controlling the warning circuit to indicate an overweight state and a safety state of the cabinet, respectively.

7. The cabinet of claim 6, wherein the warning circuit comprises a sound alarm device which makes a sound when receiving the first control signal from the control circuit.

8. The cabinet of claim 6, wherein the warning circuit comprises a light alarm device to emit a light with a predetermined color and/or a predetermined flickering frequency when receiving the first control signal from the control circuit.

9. The cabinet of claim 1, wherein the A/D converting circuit is an integrated circuit.

10. The cabinet of claim 1, wherein the control circuit is an advanced reduced instruction-set computing (RISC) machine chip.

11. An overweight alarm device for sensing a weight of an object and generating a warning when the object is overweight, the overweight alarm device comprising:
a weighing circuit comprising at least one weighing sensor configured for sensing the weight of the object;
an A/D (Analog to Digital) converting circuit coupled to the at least one weighing sensor for converting the weight to a digital signal; and
a control circuit coupled to the A/D converting circuit and having a predetermined threshold value stored therein, the control circuit comparing the digital signal with the threshold value and outputting one of a plurality of control signals according to the comparison result; and
a warning circuit coupled to the control circuit to generate the warning according to a control signal indicating that the comparison result is that the object is overweight.

12. The overweight alarm device of claim 11, further comprising a display device for displaying the weight of the object thereon.

13. The overweight alarm device of claim 12, wherein the display device comprises a liquid display screen embedded in one lateral side of the object.

14. The overweight alarm device of claim 11, wherein the control circuit outputs a first control signal to the warning circuit when the digital signal is larger than the threshold value and a second control signal to the warning circuit when the digital signal is smaller than the threshold value, controlling the warning circuit to indicate an overweight state and a safety state of the object, respectively.

15. The overweight alarm device of claim 14, wherein the warning circuit comprises a sound alarm device which makes a sound when receiving the first control signal from the control circuit.

16. The overweight alarm device of claim 14, wherein the warning circuit comprises a light alarm device to emit a light with a predetermined color and/or a predetermined flickering frequency when receiving the first control signal from the control circuit.

17. The overweight alarm device of claim 11, wherein the object is a cabinet for accommodating a plurality of electronic devices therein.
